(19) United States
(12) Patent Application Publication
(10) Pub. No.: US 2012/0293734 A1
(43) Pub. Date: Nov. 22, 2012

(54) OPTICALLY ANISOTROPIC ELEMENT, POLARIZING PLATE, STEREOSCOPIC DISPLAY DEVICE, AND STEREOSCOPIC DISPLAY SYSTEM

(75) Inventors: Ryuji SANETO, Kanagawa (JP); Shinichi MORISHIMA, Kanagawa (JP); Masato MORITA, Kanagawa (JP); Naoyoshi YAMADA, Kanagawa (JP)

(73) Assignee: FUJIFILM Corporation, Tokyo (JP)

(21) Appl. No.: 13/469,708

(22) Filed: May 11, 2012

(30) Foreign Application Priority Data
May 13, 2011 (JP) 2011-108585
Apr. 16, 2012 (JP) 2012-093183

(51) Int. Cl. G02F 1/13363; G02B 27/26; G02B 5/30

(52) U.S. Cl. 349/15; 359/486.01; 359/465

(57) ABSTRACT

Reduction of crosstalk of a stereoscopic display device equipped with an optically anisotropic element having a finely patterned optically anisotropic layer. The optically anisotropic element has a patterned optically anisotropic layer which contains a first retardation area and a second retardation area differing from each other in at least either the direction of in-plane slow axes or the in-plane retardation, and the first and second retardation area being alternately arranged in plane, the patterned optically anisotropic layer being disposed on a surface of a laminate having a first film and a second film, while an in-plane slow axes of the first and an in-plane slow axis the second film being orthogonal to each other.

The present application claims the benefit of priority from Japanese Patent Application No. 108585/2011, filed on May 13, 2011, Japanese Patent Application No. 093183/2012, filed on Apr. 16, 2012, and the contents of which are herein incorporated by reference in their entirety.

### BACKGROUND OF THE INVENTION

1. Field of the Invention

The present invention relates to an optically anisotropic element having a high-definition alignment pattern; and a polarizing plate, a stereoscopic display device, and a stereoscopic display system using the same.

2. Description of the Related Art

Stereo (3D) image display device for displaying stereoscopic needs an optical component typically for producing right-eye image and left-eye image which are circular polarized with reverse directionality. This sort of optical component typically adopts a patterned optically anisotropic element having areas, differing from each other in the direction of slow axis and/or retardation, periodically arranged in plane.

Support used for composing the patterned optically anisotropic element is classified into two types: glass support and film support. While the glass support have widely been used by virtue of its advantages over the film support, such that expansion/shrinkage under heating/cooling in the manufacturing process, or expansion/shrinkage due to time-dependent changes in temperature and humidity may be suppressed. There has, however, been a growing trend of using the patterned optically anisotropic element having the film support (also referred to as “FPR: film patterned retarder”, hereinafter), from the economical viewpoint.

Commercially available film, however, has a certain extent of retardation in general, and is causative of crosstalk which has not been emerging so long as the optically-isotropic glass support has been used as the support. Japanese Examined Patent Publication No. 4508280 proposes a phase difference element having an FPR, which includes a base film composed of a resin film, and a patterned retardation layer having two types of retardation area differing from each other in the direction of slow axes, while aligning the bisector of the slow axes of the retardation areas and the slow axis of the base film in parallel. The phase difference element is aimed at solving unbalance in ghost ascribable to the crosstalk, but does not intrinsically suppress the crosstalk.

### SUMMARY OF THE INVENTION

The present invention was aimed at solving the above-described problems, and an object of which is to reduce the crosstalk of stereoscopic display device equipped with an optically anisotropic element having a finely patterned optically anisotropic layer.

More specifically, it is an object of the present invention to provide a stereoscopic display device reduced in crosstalk; and a polarizing plate, a stereoscopic display system, and an optically anisotropic element used therefor.

The means to solve the above problems are as follows:

<1> An optically anisotropic element having a patterned optically anisotropic layer which contains a first retardation area and a second retardation area differing from each other in at least either the direction of in-plane slow axes or the in-plane retardation; and

wherein the first and second retardation area are alternately arranged in plane,

the patterned optically anisotropic layer is disposed on a surface of a laminate having a first film and a second film; and

an in-plane slow axis of the first and an in-plane slow axis of the second film are orthogonal to each other.

<2> The optically anisotropic element according to <1>, wherein difference between values of the in-plane retardation Re(550) at 550 nm of the first film and the second film is 8 nm or smaller.
<3> The optically anisotropic element according to <1> or <2>, wherein each of the values of in-plane retardation Re(550) at 550 nm of the first film and the second film is 20 nm or smaller.
<4> The optically anisotropic element according to any one of <1> to <3>, wherein either one of the first film and the second film has the slow axis aligned in parallel with the MD direction, and the other has the slow axis aligned in parallel with the TD direction.
<5> The optically anisotropic element according to any one of <1> to <4>, having no other layer between the first film and the second film, or having only an optically isotropic layer between the first film and the second film.
<6> The optically anisotropic element according to any one of <1> to <5>, further comprising a surface layer composed of a cured film, disposed on the surface of the laminate opposite to the surface thereof having the patterned optically anisotropic layer disposed thereon.
<7> An optically anisotropic element comprising a third film, a patterned optically anisotropic layer, and a fourth film laminated in this order,

wherein the patterned optically anisotropic layer contains a first retardation area and a second retardation area differing from each other in at least either the direction of in-plane slow axes or the in-plane retardation, and the first and second retardation area are alternately arranged in plane,

the third and fourth films have their in-plane slow axes in parallel with, or normal to the direction of molecular alignment, and,

the in-plane slow axes are aligned orthogonal to each other.

<8> The optically anisotropic element according to <7>, wherein difference between values of the in-plane retardation Re(550) at 550 nm of the third film and the fourth film is 8 nm or smaller.
<9> The optically anisotropic element according to <7> or <8>, wherein each of the values of in-plane retardation Re(550) at 550 nm of the third film and the fourth film is 20 nm or smaller.
<10> The optically anisotropic element according to any one of <7> to <9>, further comprising a surface layer composed of a cured film, disposed on the surface of the third film opposite to the surface thereof having the patterned optically anisotropic layer disposed thereon.
<11> A polarizing plate comprising a polarizing film, and an optically anisotropic element described in any one of <1> to <10>.
<12> The polarizing plate according to <11>, wherein the optically anisotropic element is the optically anisotropic element described in any one of <1> to <6>, the patterned optically anisotropic layer being bonded to the polarizing film.
<13> The polarizing plate according to <11,> wherein the optically anisotropic element is the optically anisotropic element described in any one of <7> to <10>, the fourth film being bonded to the polarizing film.
<14> A stereoscopic display device comprising at least:

a display panel driven based on image signals: and

the optically anisotropic element described in any one of <1> to <10>, disposed on the viewer's side of the display panel.

<15> The stereoscopic display device according to <14>, wherein the display panel has a liquid crystal cell.
<16> A stereoscopic display system comprising at least the stereoscopic display device described in <14> or <15>, and a polarizing plate disposed on the viewer's side of the stereoscopic display device, configured to allow recognition of stereoscopic through the polarizing plate.

According to the present invention, crosstalk of a stereoscopic display device, equipped with an optically anisotropic element having a finely patterned optically anisotropic layer, may be reduced.

More specifically, the present invention successfully provides a stereoscopic display device reduced in crosstalk; and a polarizing plate, stereoscopic display system, and an optically anisotropic element used therefor.

### BRIEF DESCRIPTION OF THE DRAWINGS

FIG. 1 is a schematic cross sectional view illustrating an exemplary optically anisotropic element according to a first embodiment of the present invention;

FIG. 2 is a schematic cross sectional view illustrating an exemplary optically anisotropic element according to the first embodiment of the present invention, having a surface layer composed of a cured film on the external surface;

FIG. 3 is a schematic cross sectional view illustrating an exemplary optically anisotropic element according to the first embodiment of the present invention, having the surface layer composed of a hard coating layer and an antireflection film;

FIG. 4 is a schematic cross sectional view illustrating an exemplary optically anisotropic element according to the first embodiment of the present invention, having a second film formed by coating;

FIG. 5 is a schematic drawing illustrating an exemplary relation of alignment of a film having the slow axis in the MD direction and a film having the slow axis in the TD direction, in the first embodiment;

FIGS. 6A and 6B are schematic top views illustrating exemplary patterned λ/4 layers;

FIG. 7 is a schematic cross sectional view illustrating an exemplary polarizing plate having the optically anisotropic element illustrated in FIG. 3;

FIGS. 8A and 8B are schematic drawings illustrating exemplary relations of alignment of the polarizing film and the optically anisotropic layer in the first embodiment;

FIG. 9 is a schematic cross sectional view illustrating an exemplary optically anisotropic element according to a second embodiment of the present invention;

FIG. 10 is a schematic cross sectional view illustrating an exemplary optically anisotropic element according to the second embodiment of the present invention, having a surface layer composed of a cured film on the external surface;

FIG. 11 is a schematic cross sectional view illustrating an exemplary optically anisotropic element according to the second embodiment of the present invention, having the surface layer composed of a hard coating layer and an antireflection film;

FIG. 12 is a schematic cross sectional view illustrating an exemplary polarizing plate having the optically anisotropic element illustrated in FIG. 11; and

FIG. 13 is a schematic drawing for explaining methods of evaluation in Examples.

### BEST MODES FOR CARRYING OUT THE INVENTION

The invention is described in detail hereinunder. Note that, in this patent specification, any numerical expressions in a style of “ . . . to . . . ” will be used to indicate a range including the lower and upper limits represented by the numerals given before and after “to”, respectively.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program. When a film to be analyzed is expressed by a monoaxial or biaxial index ellipsoid, Rth(λ) of the film is calculated as follows.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B):

$$Re ( θ ) = [ nx - \frac{ny \times nz}{\sqrt{\begin{matrix}{( ny sin ( {sin}^{- 1} ( \frac{sin ( - θ )}{ny} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (B)

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth (λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In the description, the term “visible light” is used for any light having wavelengths from 380 nm to 780 nm. In the description, the wavelength of measurement is 550 nm as far as there is no specific notation.

In the description, the angles (for example, “90°”) and the relations thereof (for example, expression of “orthogonal”, “parallel” or “crossed by 45°”) should be interpreted so as to include errors generally acceptable in the technical field to which the present invention belongs. For example, the angle desirably falls within a range of an exact angle ±an angle less than 10°, more desirably within a range of an exact angle ±5°, or even more desirably within a range of an exact angle ±3°.

MD direction is a direction which a film is feed to in a continued production, and TD direction is orthogonal to the MD direction.

Dimensional variation in the context of the present invention denotes variation of 0.2% or larger when compared between conditions of 25° C. with 10% humidity, and of 25° C. with 80% humidity. The rate of dimensional change herein will be defined as follows:

rate of dimensional change={dimension measured at 25° C., 80% humidity)-(dimension measured at 25° C., 10% humidity)}/(dimension measured at 25° C., 60% humidity)

According to a first embodiment of the present invention, there is provided an optically anisotropic element having a patterned optically anisotropic layer which contains a first retardation area and a second retardation area differing from each other in at least either the direction of in-plane slow axes or the in-plane retardation, and the first and second retardation area are alternately arranged in plane.

The patterned optically anisotropic layer is disposed on a surface of a laminate having a first film and a second film, wherein an in-plane slow axis of the first and an in-plane slow axis the second film are orthogonal to each other.

FPR using a flexible film as the support has various advantages over a rigid glass plate including better handlability. It is, however, difficult to completely make the film optically isotropic, and retardation remains to some degree in general, unlike the optically isotropic glass plate. The FPR therefore suffers from a problem that the state of polarization of light, passed through the patterned optically anisotropic layer, varies while being affected by the retardation of the support film, to thereby make the crosstalk more distinctive. In contrast, since the present invention uses, as the support, a laminate of the first and second films disposed so as to normally cross their in-plane slow axis, so that the retardation of the first and second films are canceled to substantially zero. Accordingly, the state of polarization of light passed through the patterned optically anisotropic layer does not change even after passed through the laminate, and thereby the crosstalk may be suppressed from occurring. The present invention intrinsically resolves occurrence of crosstalk, and is therefore understood as totally different, in the technical spirit, from the prior art aimed at reducing lateral unbalance in expression of crosstalk presupposing that it is inevitable.

Possibility of cancellation of retardation to zero, by disposing two retardation films while aligning their in-plane slow axes orthogonal to each other, may be understood as results of reduced retardation in all directions.

At least either one of the first and second films is preferably a self-supporting film. The both may be self-supporting polymer films; or one may be a self-supporting polymer film and the other is a non-self-supporting film formed on the polymer film by coating, transfer or the like.

It is preferable that no layer is disposed between the first and second films, or only an optically isotropic layer (pressure sensitive adhesive layer, for example) is disposed in between.

The optically anisotropic element of the present invention is used for stereoscopic display devices. More specifically, it is disposed together with the polarizing film, outside on the viewer's side of a display panel (for the display panel having a polarizing film on the viewer's side, it is disposed further outside of the polarizing film on the viewer's side of the display panel). Polarized images which came respectively through the first and second retardation areas of the optically anisotropic element are recognized, through polarized glasses or the like, as images for right eye and left eye.

Several modes of the first embodiment of the present invention will be explained referring to the attached drawings. Note that relative relations among thickness of the individual layers illustrated herein do not exactly reflect those in the actual configuration. Note also that the same constituents in the drawings will be given same reference numerals, so as to occasionally avoid repetitive description of the details.

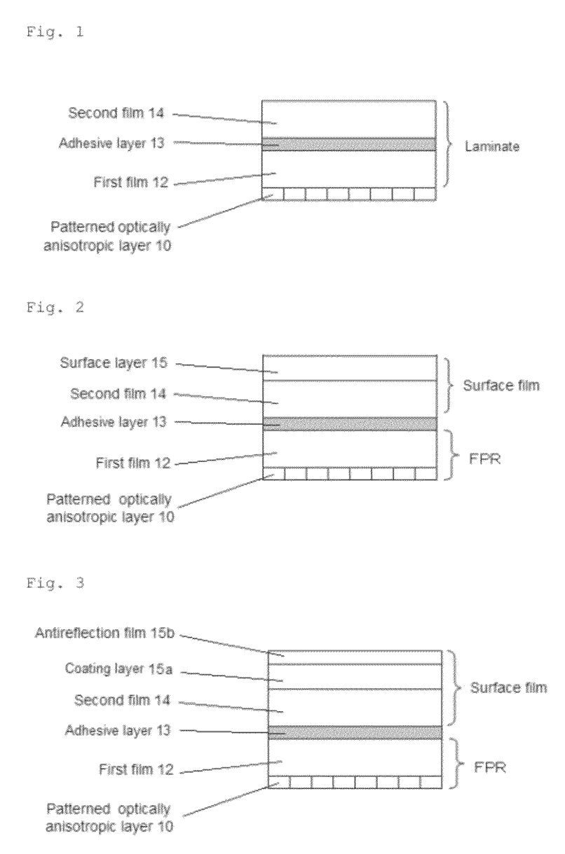

A schematic cross sectional view illustrating an exemplary optically anisotropic element of the present invention is shown in FIG. 1. The optically anisotropic element illustrated in FIG. 1 has a patterned optically anisotropic layer 10, formed over a laminate of a first film 12 and a second film 14. Since the first film 12 and the second film 14 are laminated so as to align their in-plane slow axes orthogonal to each other, so that the retardation is canceled to thereby give a total retardation of the laminate of substantially zero. In the illustrated example of FIG. 1, a pressure sensitive adhesive layer 13 is disposed between the first film 12 and the second film 14 in order to integrate the both, so that the pressure sensitive adhesive layer 13 is preferably an optically isotropic layer, from the viewpoint that the laminate as a whole achieves a retardation of zero.

Light passed through the first and second retardation areas of the patterned optically anisotropic layer 10 is polarized to a predetermined degree depending on the retardation and the direction of the slow axes of the individual areas, to thereby give polarized images for the right eye and left eye. The polarized images for the right eye and left eye then pass through the first film 12 and the second film 14, while keeping the state of polarization thereof unchanged, because the retardation of the laminate as a whole is zero as described in the above. In this way, crosstalk of the images for the right eye and left eye may be suppressed.

Such effect of reducing crosstalk may be obtained if only the first film 12 and the second film 14 are laminated so as to align their slow axes orthogonal to each other, without special limitation on the direction of the individual slow axes. As schematically illustrated in FIG. 5, it is preferable if either one of the first film 12 and the second film 14 is a film having the slow axis in the MD direction, and the other is a film having the slow axis in the TD direction, since they may be laminated by a roll-to-roll process, to thereby facilitate manufacturing of the optically anisotropic element.

In general, the slow axis of film appears in parallel with, or orthogonal to, the direction of molecular alignment achieved typically by stretching. The film generally tends to cause dimensional change in the direction of molecular alignment or the direction orthogonal thereto. Accordingly, if the first film 12 and the second film 14 are two films having their in-plane slow axes aligned in parallel with the direction of molecular alignment, or two films having their in-plane slow axes aligned orthogonal to the direction of molecular alignment, and are laminated so as to align their in-plane slow axes orthogonal to each other, changes in the optical characteristics ascribable to dimensional changes of the laminate as a whole may be reduced, and thereby the crosstalk ascribable thereto may further be reduced.

The smaller the difference of Re(550) between the first film 12 and the second film 14 is, the better. More specifically, the difference is preferably 8 nm or smaller, and ideally 0 nm. Also for Re(550) of each of the first film 12 and the second film 14, the smaller is the better. More specifically, it is preferably 20 nm or smaller. On the other hand, Re(550) is 1 nm or larger when difficulty in the manufacturing is taken into account, and Re(550) is 3 nm or larger from the viewpoint of availability of general-purpose film. If the difference of Re(550) between the first film 12 and the second film 14 is 8 nm or smaller, and Re(550) of each film is 20 nm or smaller, cancellation of retardation by virtue of the orthogonal alignment of the in-plane slow axes may be more extensive, and thereby the crosstalk may further be reduced.

FIG. 2 is a schematic cross sectional view illustrating an optically anisotropic element having a surface layer composed of a cured film 15 on the external surface. Since the optically anisotropic element is disposed on the exterior on the viewer's side of the display panel, so that the surface layer 15 preferably functions as a protector against external physical impact, and as an anti-reflector for preventing reflection of external light. The surface layer 15 is exemplified by a hard coating layer and antireflection film. The surface layer 15 may include two or more layers. One example, illustrated in FIG. 3, has a hard coating layer 15a and an antireflection film 15b. While the configuration of this embodiment has the surface layer 15 directly provided on the surface of the second film 14, an additional functional layer may be provided between the second film 14 and the surface layer 15.

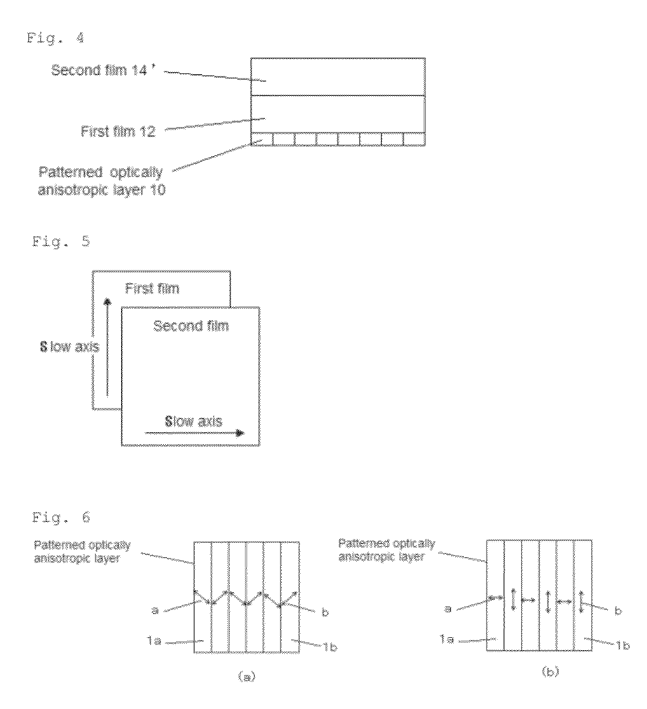

FIG. 4 illustrates an embodiment in which the second film 14′ is composed of a non-self-supporting layer such as a protective layer formed typically by coating. The second film 14′ is not specifically limited in the materials and functions thereof, so long as it has the slow axis aligned orthogonal to the slow axis of the first film 12. For example, it may be a hard coating layer having a protective function against external physical impact. Since the second film 14′ of this embodiment may be formed directly on the surface of the first film 12 typically by coating, so that there is no pressure sensitive adhesive layer provided between the first film 12 and the second film 14′.

The patterned optically anisotropic layer 10 illustrated in FIG. 1 to FIG. 4 includes a first retardation area and a second retardation area differing from each other in at least either the direction of in-plane slow axes or the in-plane retardation. Polarized images which passed through the first and second retardation area are recognized as images for right eye and left eye, respectively, typically through polarized glasses. Accordingly, the first and second retardation areas preferably have the same geometry, and preferably arranged in a balanced and symmetrical manner, in order to avoid unbalance between the images for left and right eyes.

One example of the patterned optically anisotropic layer is a patterned λ/4 layer having the first and second retardation areas respectively characterized by an in-plane retardation Re of λ/4, and by the slow axes thereof aligned orthogonal to each other. FIGS. 6A and 6B are schematic top views illustrating exemplary patterned λ/4 layer. The first and second retardation areas 1a and 1b illustrated in FIGS. 6A and 6B respectively have an in-plane retardation of λ/4 or around, and respectively have in-plane slow axes “a” and “b” aligned orthogonal to each other. By combining the patterned optically anisotropic layer of this embodiment with a polarizing film, light passed respectively through the first and second retardation areas is converted into circular polarized lights having counter directions, so as to give circular polarized images for right eye and left eye.

The patterned optically anisotropic layer is not limited to the embodiment described in the above. Another adoptable configuration of the patterned optically anisotropic layer is such that either one of the first and second retardation areas has an in-plane retardation of λ/4, and the other has 3λ/4. Still another adoptable configuration of the patterned optically anisotropic layer is such that the either one of the first and second retardation areas 1a and 1b has an in-plane retardation of λ/2, and the other has 0.

Geometry and pattern of arrangement of the first and second retardation areas 1a and 1b are not limited to those in the alternating arrangement of stripe areas as illustrated in FIGS. 6A and 6B. One adoptable example is a lattice-like arrangement of rectangular patterns.

The patterned optically anisotropic layer may have a single-layered structure, or may have a multi-layered structure composed of two or more layers. The patterned optically anisotropic layer may be composed of one, or two or more species of compositions having a polymerizable group-containing liquid crystal compound as a major constituent.

Directionality of the in-plane slow axes of the individual patterned areas of the optically anisotropic layer is adjustable into directions differing from each other, typically orthogonal to each other, by using a patterned alignment film or the like. The patterned alignment film adoptable herein includes both of a photo-alignment film having alignability thereof given by exposure to light through a mask, and a rubbed alignment film having alignability thereof given by rubbing through a mask. Alternatively, an alignment control technique based on nano-imprinting, without using the patterned alignment film, is adoptable.

The optically anisotropic element of the present invention is not limited to those illustrated in FIG. 1 to FIG. 4, and may include other components. For example, in an embodiment where the patterned optically anisotropic layer is configured by using an alignment film as described in the above, the alignment film may be provided between the first film and the patterned optically anisotropic layer. On the external surface, a forward scattering layer, a primer layer, an antistatic layer, an undercoat or the like may be provided, together with (or in place of) the hard coating layer and the antireflection film.

The present invention also relates to a polarizing plate. The polarizing plate of the present invention has at least a polarizing film, and an optically anisotropic element of the present invention. A preferable embodiment is such that the patterned optically anisotropic layer of the optically anisotropic element of the present invention is bonded to the polarizing film.

FIG. 7 is a schematic cross sectional view illustrating an exemplary polarizing plate having the optically anisotropic element illustrated in FIG. 3. In the polarizing plate illustrated in FIG. 7, a liner polarizing film 16 is disposed on the surface of the patterned optically anisotropic layer 10 of the optically anisotropic element. It is preferable that there is no layer, or only an optically isotropic layer (a pressure sensitive adhesive layer, for example), disposed between the patterned optically anisotropic layer 10 and the liner polarizing film 16.

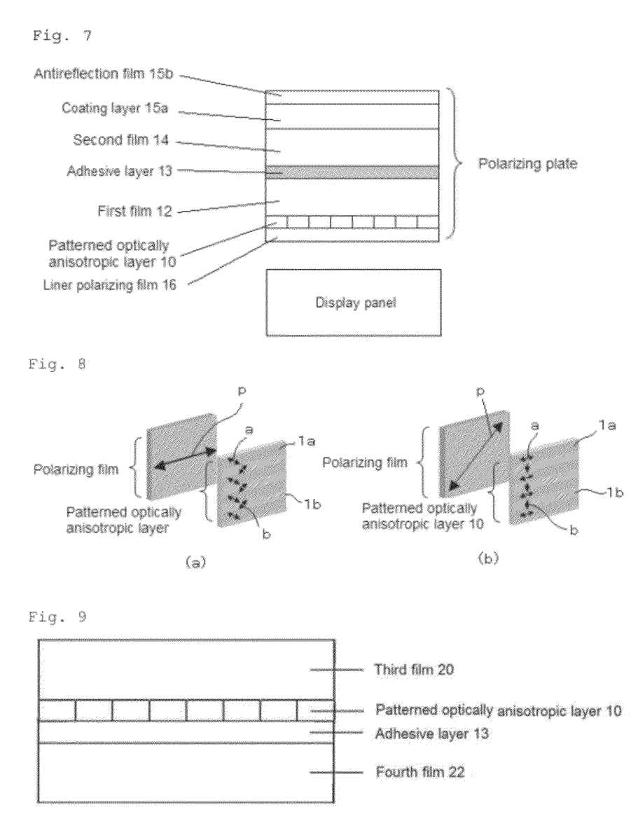

In the individual examples where the patterned optically anisotropic layer 10 has the patterned λ/4 layers illustrated in FIGS. 6A and 6B, the first and second retardation areas 1a and 1b are arranged respectively as illustrated in FIGS. 8A and 8B so as to align their in-plane slow axes “a” and “b” respectively ±45° away from the transmission axis of the liner polarizing film 16. The present invention, however, does not require ±45° in the strict sense, wherein either one of the first and second retardation areas 1a and 1b are preferably aligned at an angle of 40 to 50°, whereas the other preferably aligned at an angle of −50 to −40°. By virtue of this configuration, the circular polarized images for right eye and left eye may be separated. The viewing angle may be expanded by further stacking a λ/2 plate. The slow axis of either one of the first and second films is preferably aligned in parallel with the transmission axis of the polarizing film, and the other is aligned orthogonal thereto. More specifically, in the example illustrated in FIG. 8A, the slow axis of either one of the first and second films is preferably aligned in the MD direction and the other is aligned orthogonal thereto, whereas in the example illustrated in FIG. 8B, the slow axis of either one of the first and second films is preferably aligned in the direction 45° away from the MD direction, and the other is aligned 135° away from the MD direction.

The present invention also relates to a stereoscopic display device having at least the optically anisotropic element of the present invention, and a display panel. The optically anisotropic element is disposed on the surface on the viewer's side of the display panel, and separate the incident polarized light into polarized images for right and left eyes (circular polarized images, for example). The viewer observes the polarized images through a polarizing plate such as polarized glasses (circular polarized glasses, for example), and recognizes them as a stereoscopic.

While the optically anisotropic element of the present invention is disposed, together with the polarizing film, on the surface on the viewer's side of the display panel as illustrated in FIG. 7, the polarizing film is omissible if the display panel has a polarizing film on the viewer's side. In the embodiment such that the optically anisotropic element of the present invention is disposed together with the polarizing film, on the display panel having the polarizing film on the viewer's side as illustrated in FIG. 7, the polarizing film is disposed so that the transmission axis thereof coincides with the transmission axis of the polarizing film disposed on the viewer's side of the display panel.

According to a second embodiment of the present invention, there is provided an optically anisotropic element comprising a third film, a patterned optically anisotropic layer, and a fourth film laminated in this order.

The patterned optically anisotropic layer contains a first retardation area and a second retardation area differing from each other in at least either the direction of in-plane slow axes or the in-plane retardation, and the first and second retardation area are alternately arranged in plane.

The third film and the fourth film have their in-plane slow axes aligned in parallel with, or normal to the direction of molecular alignment, and, their in-plane slow axes are aligned orthogonal to each other.

While FPR using a flexible film as a support enjoys various advantages over use of a rigid glass plate, including excellent handlability, it suffers from a problem of fluctuation in the optical characteristics due to dimensional changes induced by heat, humidity and so forth. Fluctuation in the optical characteristics increases the crosstalk.

Now the slow axis of film is aligned in parallel with, or orthogonal to the direction of molecular alignment typically achieved by stretching. The dimensional changes generally occur in the direction orthogonal to the direction of alignment of molecules composing the film. The present invention succeeded in moderating the fluctuation in the optical characteristics due to dimensional changes, and in reducing the cross talk as a consequence, by providing two films having the in-plane slow axes thereof aligned in the direction in parallel with, or orthogonal to the direction of molecular alignment, so as to align their in-plane slow axes orthogonal to each other. A preferable case includes that both of the third and fourth films have their in-plane slow axes in the direction in parallel with the direction of molecular alignment, or in the direction normal to the direction of molecular alignment.

In other words, both of the third and fourth films might cause dimensional changes, but successfully cancel fluctuation in the optical characteristics due to the dimensional changes, to thereby give substantially no fluctuation in the optical characteristics as a whole. Accordingly, optical characteristics of light passed through the patterned optically anisotropic layer does not change at all even after passing through the element, and thereby the crosstalk may be suppressed. The present invention thus intrinsically resolves occurrence of crosstalk, and is therefore understood as totally different in the technical spirit from the prior art aimed at reducing lateral unbalance in expression of crosstalk, presupposing that the crosstalk is inevitable.

At least either one of the third and fourth film is preferably a self-supporting film, and the both are preferably self-supporting polymer films.

The optically anisotropic element of the present invention is used for composing a stereoscopic display device. More specifically, it is disposed, together with the polarizing film, externally on the viewer's side of the display panel (for the display panel having a polarizing film on the viewer's side, it is disposed further externally of the polarizing film on the viewer's side of the display panel). Polarized images which came respectively through the first and second retardation areas of the optically anisotropic element are recognized, through polarized glasses or the like, as images for right eye and left eye.

Several modes of the second embodiment of the present invention will be explained referring to the attached drawings. Note that relative relations among thickness of the individual layers illustrated herein do not exactly reflect those in the actual configuration. Note also that the same constituents in the drawings will be given same reference numerals, so as to occasionally avoid repetitive description of the details. All constituents same as those described in the first embodiment will be given same reference numerals.

FIG. 9 is a schematic cross sectional view illustrating an exemplary optically anisotropic element of the present invention. The optically anisotropic element illustrated in FIG. 9 has a third film 20, a patterned optically anisotropic layer 10, and a fourth film 22 laminated in this order. In the general process, an alignment film or the like is formed on the third film 20, and the patterned optically anisotropic layer 10 is then formed thereon. Dimensional changes in the third film 20 and the fourth film 22 may be canceled, fluctuation in the optical characteristics due to the dimensional changes may be moderated as a consequence, and thereby the crosstalk is reduced. In the example illustrated in FIG. 9, a pressure sensitive adhesive layer 13 is provided between the fourth film 22 and the optically anisotropic layer 10 aiming at integrating the both. For the purpose of minimizing the fluctuation in the optical characteristics of the optically anisotropic element as a whole, the pressure sensitive adhesive layer 13 is preferably a layer having a small fluctuation in the optical characteristics. In addition, a layer disposed between the third film 20 and the patterned optically anisotropic layer 10, or between the patterned optically anisotropic layer 10 and the fourth film 22, preferably contains only a layer substantially not causative of inducing dimensional changes. “Substantially not causative of inducing dimensional changes” herein means that, for example, the rate of dimensional change is 0.2% or smaller.

Light passed through the first and second retardation areas of the patterned optically anisotropic layer 10 is converted into polarized lights, having the state determined by the retardation and the direction of slow axes of the individual areas, to thereby form polarized images for right eye and left eye. The polarized images for right eye and left eye then pass through the third film 20 and the fourth film 22. Since the fluctuation in the optical characteristics of the third film 20 and the fourth film 22 due to the dimensional changes may be canceled as described in the above, the crosstalk of the images for the left and right eyes may be suppressed.

An effect of reducing the crosstalk is obtainable only if the third film 20 and the fourth film 22 respectively have their in-plane slow axes aligned normal to, or in parallel with the molecular alignment, and, have their in-plane slow axes aligned orthogonal to each other, without special limitation on the individual directions.

The smaller the difference of Re(550) between the third film 20 and the fourth film 22 is, the better. More specifically, the difference is preferably 8 nm or smaller, and ideally 0 nm. Also for Re(550) of each of the third film 20 and the fourth film 22, the smaller is the better. More specifically, it is preferably 20 nm or smaller. On the other hand, Re(550) is 1 nm or larger when difficulty in the manufacturing is taken into account, and Re(550) is 3 nm or larger from the viewpoint of availability of general-purpose film. If the difference of Re(550) between the third film 20 and the fourth film 22 is 8 nm or smaller, and Re(550) of each film is 20 nm or smaller, cancellation of retardation by virtue of the orthogonal alignment of the in-plane slow axes may be more extensive, and thereby the crosstalk may further be reduced.

Each of the third film 20 and the fourth film 22 generally shows a rate of dimensional change of 0.1 to 0.5%.

FIG. 10 is a schematic cross sectional view of an optically anisotropic element having, on the external surface thereof, a layer composed of a cured film 15. Since the optically anisotropic element is disposed externally on the viewer's side of the display panel, so that the surface layer preferably functions to protect the element from the external physical impact, and to suppress thereon reflection of external light. Examples of the surface layer 15 include hard coating layer and antireflection film. The surface layer 15 may contain two or more layers, an examples of which relates to the one illustrated in FIG. 11, configured to have a hard coating layer 15a and an antireflection film 15b. While the third film 20 in this embodiment is provided with the surface layer 15 directly on the surface thereof, a functional layer may additionally be provided between the third film 20 and the surface layer 15.

As seen in FIG. 9 to FIG. 11, the patterned optically anisotropic layer 10 contains the first retardation area and the second retardation area differing from each other in at least either the direction of in-plane slow axes or the in-plane retardation. Polarized images which came respectively through the first and second retardation areas of the optically anisotropic element are recognized, through polarized glasses or the like, as images for right eye and left eye. Accordingly, the first and second retardation areas preferably have the same geometry, and preferably arranged in a balanced and symmetrical manner, in order to avoid unbalance between the images for left and right eyes.

Details of the patterned optically anisotropic layer may be referred to the first embodiment described in the above.

The optically anisotropic element according to the second embodiment of the present invention is not limited to the embodiments illustrated in FIG. 9 to FIG. 11, and may include other constituents. Descriptions relevant to this aspect may be referred to the first embodiment described in the above.

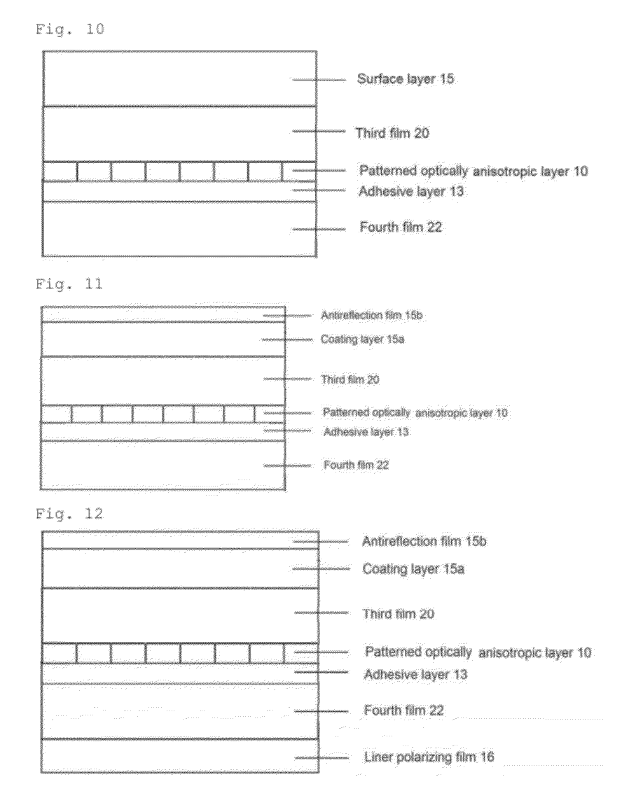

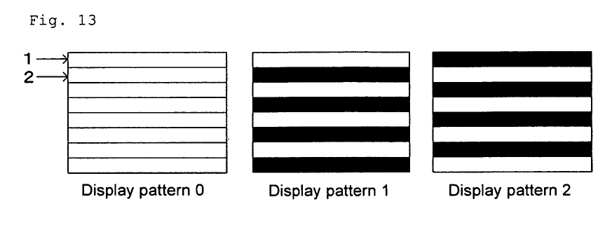

FIG. 12 is a schematic cross sectional view illustrating an exemplary polarizing plate having the optically anisotropic element of the second embodiment illustrated in FIG. 11.

In the individual examples where the patterned optically anisotropic layer 10 has the patterned λ/4 layers illustrated in FIGS. 6A and 6B, the first and second retardation areas 1a and 1b are arranged respectively as illustrated in FIGS. 8A and 8B so as to align their in-plane slow axes “a” and “b” respectively ±45° away from the transmission axis of the liner polarizing film 16. The present invention, however, does not require angles of ±45° in the strict sense, wherein either one of the first and second retardation areas 1a and 1b is preferably directed to an angle of 40 to 50°, whereas the other is preferably directed to an angle of −50 to −40°. By virtue of this configuration, the circular polarized images for right eye and left eye may be separated. The viewing angle may be expanded by further stacking a λ/2 plate. The slow axis of either one of the third and fourth films is preferably aligned in parallel with the transmission axis of the polarizing film, and the other is aligned orthogonal thereto.

### <Display Panel>

There is no limitation on the display panel in the present invention. The display panel may be a liquid crystal panel having a liquid crystal layer, or may be an organic EL display panel having an organic EL layer, or may be a plasma display panel. All of these embodiments may adopt various possible configurations. While the liquid crystal panel, for example, has a polarizing film for image display on the viewer's side thereof, the optically anisotropic element of the present invention may alternatively achieve the above-described function as a result of being combined with the polarizing film.

One example of the display panel is a transmission-mode liquid crystal panel, having a pair of polarizing films and a liquid crystal cell disposed in between. Between each of the polarizing films and the liquid crystal cell, generally provided is a retardation film for compensating viewing angle. Any liquid crystal cell having general configuration is adoptable herein, without special limitation. The liquid crystal cell includes, for example, a pair of substrates opposed to each other, and a liquid crystal layer held between the pair of substrates, and may further include a color filter layer and so forth as occasion demands. Various drive modes of the liquid crystal cell, including twisted nematic (TN) mode, super twisted nematic (STN) mode, vertical alignment (VA) mode, in-plane switching (IPS) mode, optically compensated bend cell (OCB) mode, are adoptable herein again without special limitation.

The present invention also relates to a stereoscopic display system which includes at least the stereoscopic display device of the present invention, and a polarizing plate disposed on the viewer's side of the stereoscopic display device, configured to allow recognition of stereoscopic through the polarizing plate. One example of the polarizing plate disposed outside on the viewer's side of the stereoscopic display device is polarized glasses worn by the viewer. The viewer observes the polarized images for right and left eyes displayed on the stereoscopic display device through the circular or linear polarized glasses, and recognizes them as a stereoscopic.

Various constituents for composing the optically anisotropic element of the present invention will be detailed below.

### <Optically Anisotropic Element>

The optically anisotropic element of the present invention has the patterned optically anisotropic layer on the surface of the laminate of the first and second films, or on the surface of the third film. While a method of manufacturing of the patterned optically anisotropic layer is not specifically limited, it is general to provide the alignment film on the surface of the first film or the third film, and the patterned optically anisotropic layer is provided on the surface of the alignment film.

In the first embodiment, the second film may further be bonded, while placing a pressure sensitive adhesive layer, on the surface of the first film having no patterned optically anisotropic layer formed thereon (generally the top surface). Also for the second film, once a surface film is formed on the surface thereof typically by forming a protective layer or the like, and then the back surface of the surface film (the surface of the second film having no protective layer formed thereon), and the surface of the first film having no patterned optically anisotropic layer formed thereon, may be bonded while placing a pressure sensitive adhesive layer in between. Of course, it is also recommendable to preliminarily bond the first and second films while placing a pressure sensitive adhesive layer in between, and then to form thereon the patterned optically anisotropic layer, and the protective layer and so forth as occasion demands. The second embodiment also exemplifies a configuration where the fourth film is bonded to the surface (generally, the top surface) of the patterned optically anisotropic layer which is opposite to the surface having the third film formed thereon, while placing the pressure sensitive adhesive layer in between.

### <First to Fourth Film>

There is no special limitation on methods of manufacturing the first to fourth films. While both of solution casting and melt casting are adoptable, solution casting is preferable. The first to fourth films are preferably low-Re polymer films. The first and second films, or the third and fourth films, are preferably combined so as to ensure a small difference between the Re values.

Preferable ranges of the Re values and difference between the Re values are as described in the above.

Specific examples of material, constituting the first to fourth films for use in the present invention include polycarbonate series polymers, polyester series polymers such as polyethylene terephthalate and polyethylene naphthalate, acryl series polymers such as polymethylmethacrylate, and styrene series polymers such as polystyrene and acryl nitrile/styrene copolymer (AS resin). Specific examples thereof include also polyolefins such as polyethylene and polypropylene, polyolefin series polymers such as ethylene/propylene copolymers, vinyl chloride series polymers, amide series polymers such as nylon and aromatic polyamide, imide series polymers, sulfone series polymers, polyether sulfone series polymers, polyether ether ketone series polymers, polyphenylene sulfide series polymers, vinylidene chloride series polymers, vinyl alcohol series polymers, vinyl butyral series polymers, arylate series polymers, polyoxymethylene series polymers, epoxy series polymers and any mixtures thereof. The cured layer of any UV cure or thermal cure resins such as acryl, urethane, acryl urethane, epoxy or silicone series cure resins may be also used.

Preferable examples of the material, constituting the first to fourth films, include thermoplastic norbornene-type reins. Examples of the thermoplastic norbornene-type rein include ZEONEX and ZEONOR (manufactured by ZEON Corporation) and ARTON (manufactured by JSR Corporation.

Preferable examples of the material, constituting the first to fourth films, include also cellulose series polymers (occasionally referred to as cellulose acylate hereinafter) such as cellulose triacetate used as a transparent protective film of a polarizing plate conventionally.

The first and second films and the third and fourth films may be constituted from the same or different material, respectively.

[Stretching]

The first to fourth films may be stretched films. The retardation and the in-plane slow axis are adjustable by stretching. As described in the above, it is preferable that either one of the first and second films has the slow axis in the MD direction, and the other in the TD direction. It is also preferable that the either one of the third and fourth films has the slow axis in the MD direction, and the other in the TD direction. In general, a film having the slow axis in the MD direction may be manufactured by stretching in the MD direction, and a film having the slow axis in the TD direction may be manufactured by stretching in the TD direction.

Methods of stretching in the transverse direction (TD direction) are disclosed in JP-A-S62-115035, JP-A-H04-152125,

JP-A-H04-284211, JP-A-H04-298310, and JP-A-H11-48271, for example. The film is stretched at normal temperature, or under heating. Temperature of heating is preferably −20° C. to +100° C. while placing the glass transition temperature of the film in between. Stretching at a temperature extremely lower than the glass transition temperature may make the film more likely to rupture, and may fail to express desired optical characteristics. On the other hand, stretching at a temperature extremely higher than the glass transition temperature may fail to thermally fix the molecular alignment, due to relaxation of the alignment by heat during the stretching, and again may fail to fully express the optical characteristics.

The film may be stretched by uniaxial stretching only in the MD direction or in the TD direction, or by sequential biaxial stretching, preferably more largely in the TD direction. The film is stretched in the TD direction preferably up to 1 to 100%, more preferably up to 10 to 70%, and particularly preferably up to 20% to 60%. The film may be stretched in the MD direction preferably to 1 to 10%, and particularly preferably to 2 to 5%.

The stretching may take place in the middle of the film making process, or may be effected to a web taken up on a roll after the film making.

The stretching in the process of film making may take place in the state that the film retains therein a residual solvent. The stretching preferably takes place at a ratio of residual solvent content, given by (mass of residual volatile/mass of film after heating)×100%, of 0.05 to 50%. For the case where the web taken up on a roll after the film making is stretched, the web is preferably stretched at a ratio of residual solvent content of 0 to 5%, in the TD direction preferably up to 1 to 100%, more preferably up to 10 to 70%, and particularly preferably up to 20% to 60%.

It is still also possible to stretch the film in the process of film making, and to further stretch the resultant web taken up on a roll after the film making.

For the case where the film is stretched in the process of film making, and the resultant web taken up on a roll after the film making is further stretched, the stretching in the process of film making may take place in the state that the film retains therein the residual solvent, preferably at a ratio of residual solvent, given by (mass of residual volatile/mass of film after heating)×100%, of 0.05 to 50%, and the stretching of the web taken up on a roll after the film making may take place at a ratio of residual solvent content of 0 to 5%. The stretching in the TD direction preferably takes place up to 1 to 100%, more preferably up to to 70%, and particularly preferably up to 20% to 60%, relative to the unstretched state.

The first to fourth films may be stretched by biaxial stretching.

The biaxial stretching includes simultaneous biaxial stretching and sequential biaxial stretching. The sequential biaxial stretching is more preferable from the viewpoint of continuous manufacturing, wherein a dope is cast over a band or drum, the film is then stripped off, and then stretched in the TD direction, followed by stretching in the MD direction, or stretched in the MD direction, followed by stretching in the TD direction.

For the purpose of relaxing residual stress and reducing dimensional changes in the process of stretching, and also for the purpose of reducing variation in the direction of in-plane slow axis relative to the TD direction, the transverse stretching is preferably followed by relaxation process. In the relaxation process, the width of the relaxed film is preferably adjusted to 100 to 70% (or, a relaxation ratio of 0 to 30%) of the width of the film before relaxation. Temperature of the relaxation process preferably falls in the range from Tg−50 to Tg+50° C., where Tg is apparent glass transition temperature. In the general stretching, the film in a relaxation zone after once achieving the maximum ratio of expansion in width, is retained not longer than one minute before being sent to, and passed through a tenter zone.

The apparent Tg of the film herein, in the process of stretching, was determined from an endothermic peak observed using a differential scanning calorimeter (DSC), by placing a film containing residual solvent in an aluminum pan, and heating the film from 25° C. up to 200° C. at a rate of heating of 20° C./min.

For the case where the film is stretched in the process of film making, the film may be dried while being conveyed. Drying temperature is preferably 100° C. to 200° C., more preferably 100° C. to 150° C., still more preferably 110° C. to 140° C., and particularly preferably 130° C. to 140° C. The drying time is preferably 10 to 40 minutes, but not specifically limited thereto.

By selecting optimum drying temperature after the stretching, the residual stress in a cellulose ester film thus manufactured may be relaxed, and thereby dimensional changes, changes in the optical characteristics, and changes in the direction of slow axis under high temperatures or under high temperature/high humidity conditions, may be reduced.

For the case where the web taken up on a roll after the film making is stretched, the stretched web may further be heated. By heating the web, the residual stress in the resultant first to fourth films is relaxed, and thereby dimensional changes, changes in the optical characteristics, and changes in the direction of slow axis under high temperatures or under high temperature/high humidity conditions, may preferably be reduced. Temperature of heating is preferably 100° C. to 200° C., but not specifically limited thereto.

### <Pressure Sensitive Adhesive Layer>

The pressure sensitive adhesive layer is preferably an optically isotropic layer. Examples of pressure sensitive adhesive capable of forming the optically isotropic pressure sensitive adhesive layer include acrylate-based pressure sensitive adhesive. Any agent generally classified into adhesives is adoptable, so long as it may be used for bonding.

### <Patterned Optically Anisotropic Layer>

Materials adoptable to the patterned optically anisotropic layer include a composition mainly containing a liquid crystal compound having a polymerizable group, and retardation film such as stretched film, without special limitation. Since the optically anisotropic layer need to be patterned, so that the composition mainly containing a liquid crystal compound having a polymerizable group is preferably used, from the viewpoint of readiness of patterning.

The optically anisotropic layer may be formed by various methods making use of an alignment film, without special limitation.

A first embodiment relates to a method making use of a plurality of actions affective to alignment control of a liquid crystal, and then annihilating any of the actions by applying an external stimulus (typically by heating), so as to make a predetermined action of alignment control dominant. For example, the liquid crystal is brought into a predetermined state of alignment, by a combined action of an alignment control ability of the alignment film and an alignment control ability of an alignment controlling agent added to the liquid crystal composition, and is then fixed to form one retardation area; and either one action (the action ascribable to the alignment controlling agent) is then annihilated by an external stimulus (heating, for example) so as to make the other action of alignment control (the action ascribable to the alignment film) dominant, to thereby achieve the other state of alignment, which is successively fixed to form the other retardation area. For example, a certain kind of pyridinium compound or imidazolium compound predominantly distribute over the surface of an alignment film composed of a hydrophilic polyvinyl alcohol, by virtue of hydrophilicity of pyridinium group or imidazolium group. In particular, if the pyridinium group is further substituted by an amino group which serves as an acceptor of a hydrogen atom, the pyridinium compound will more densely distribute over the surface of the alignment film, by virtue of formation of an inter-molecular hydrogen bond between itself and polyvinyl alcohol. The pyridinium derivative aligns in the direction orthogonal to the principal chain of polyvinyl alcohol as being effected by the hydrogen bond, and thereby assists alignment of the liquid crystal orthogonal to the direction of rubbing. Since the pyridinium derivative has a plurality of aromatic rings in the molecule, so that a strong intermolecular n-n interaction emerges between itself and the above-described liquid crystal, in particular discotic liquid crystal, and thereby induces orthogonal alignment of the discotic liquid crystal at around the interface with the alignment film. In particular, for the case where the hydrophilic pyridinium group is coupled with a hydrophobic aromatic ring, the pyridinium derivative also expresses an effect of inducing vertical alignment of the liquid crystal by virtue of its effect of hydrophobicity. The effect, however, annihilates under heating exceeding a certain level of temperature, since the hydrogen bond cleaves, density of the pyridinium compound and so forth on the alignment film reduces, and the action thereof is lost. As a consequence, the liquid crystal is aligned in parallel, by the contribution of restrictive force of the rubbed alignment film per se. Details of the method are described in Japanese Patent Application No. 2010-141345, the contents of which are incorporated hereinto by reference.

A second embodiment relates to a method of using patterned alignment films. In this embodiment, the patterned alignment films differing from each other in the alignment control ability are formed, and thereon a liquid crystal composition is disposed so as to align the liquid crystal molecules. The liquid crystal molecules are anchored by the alignment control ability of the individual patterned alignment films, and are respectively brought into different states of alignment. By fixing the individual states of alignment, patterns of the first and second retardation area are formed, conforming to the pattern of the alignment films. The patterned alignment film may be formed by printing, rubbing of the alignment film to be rubbed through a mask, exposure of light on the alignment film through a mask, and so forth. Alternatively, the patterned alignment film may be formed, by uniformly forming the alignment film, and then printing thereon an additive (onium salt, for example) affective to the alignment control ability, conforming to a predetermined pattern. The method based on printing is preferable, from the viewpoint of that any large-scale facility is not necessary, and readiness of manufacturing. Details of the method are described in Japanese Patent Application No. 2010-173077, the contents of which are incorporated hereinto by reference.

The first and second embodiments may be combined. One example is such as adding a photo-acid generator in the alignment film. In this example, a photo-acid generator is added to the alignment film, and the film is exposed to light according to a predetermined pattern, so as to form an area where the photo-acid generator decomposes to produce an acidic compound, and an area having no acidic compound produced therein. The photo-acid generator in the non-exposed area remains almost undecomposed, so that interaction among the materials composing the alignment film, the liquid crystal, and the optionally added alignment controlling agent governs the state of alignment, and makes the liquid crystal align the slow axis thereof orthogonal to the direction of rubbing. On the other hand, if the acidic compound generates in the exposed area of the alignment film, the interaction is no longer predominant, instead the direction of rubbing of the rubbed alignment film governs the state of alignment, so that the liquid crystal molecules are aligned while aligning their slow axes in parallel with the direction of rubbing. The photo-acid generator adoptable to the alignment film is preferably a water-soluble compound. Examples of the adoptable photo-acid generator includes the compounds described in Prog. Polym. Sci., 23, p. 1485 (1998). Pyridinium salt, iodonium salt and sulfonium salt are particularly preferable examples of the photo-acid generator. Details of the method are described in Japanese Patent Application No. 2010-289360, the contents of which are incorporated hereinto by reference.

A third embodiment relates to a method of using a discotic liquid crystal which contains polymerizable groups differing in the polymerizability (for example, oxetanyl group and polymerizable ethylenic unsaturated group). In this embodiment, the discotic liquid crystal is brought into a predetermined state of alignment, and then exposed to light under a condition allowing only one of the polymerizable groups to proceed a polymerization reaction, to thereby form a preliminary optically anisotropic layer. Next, the discotic liquid crystal is exposed to light under a condition allowing the other polymerizable group to proceed a polymerization reaction (typically under the presence of a polymerization initiator allowing the other polymerizable group to start the polymerization), through a mask. The state of alignment in the exposed area is fully fixed, and thereby one of the retardation area having a predetermined Re value is formed. On the other hand, in the unexposed area, one of the polymerizable groups has finished the reaction, whereas the other polymerizable group has remained unreacted. Accordingly, by heating the discotic liquid crystal up to a temperature exceeding the isotropic phase transition temperature at which the reaction of the other polymerizable group can proceed, the unexposed area is fixed to the isotropic phase, showing an Re value of 0 nm.

### <Surface Layer>

The optically anisotropic element of the present invention may have a surface layer composed of a cured film, on the surface of the second film, opposite to the surface having the first film laminated thereon, or, on the surface of the third film, opposite to the surface having the patterned optically anisotropic layer provided thereon. Functions of the surface layer are not specifically limited. The surface layer may function as a hard coating layer for protecting the optically anisotropic element from the external physical impact, or may function as an antireflection film for preventing thereon reflection of external light. The surface layer may also be a laminate of the both. If the optically anisotropic element of the present invention has the surface layer such as an antireflection film, the second film or the third film functions also as a support of the surface layer.

One example is illustrated in FIG. 3 or FIG. 11, having a hard coating layer and an antireflection film laminated thereon. The surface layer may have a forward scattering layer, a primer layer, an antistatic layer, an undercoat, a protective layer or the like, together with, or in place of the above described layers. Details of the individual layers composing the antireflection film and the hard coating layer are described in paragraphs [0182] to [0220] of JP-A-2007-254699. The same antireflection film, preferable characteristics, preferable materials and so forth, will apply to the present invention.

### <Polarizing Film>

A polarizing film usable in the present invention is a typical linearly polarizing film. The polarizing film may be a stretched film or a layer formed by coating. Examples of the former include stretched films formed by stretching polyvinyl alcohol stained with iodine or a dichroic dye.

Examples of the latter include layers formed by coating dichroic dye-containing compositions and fixing the dye in a predetermined alignment state.

The term “polarizing film” here refers to linearly polarizing film.

### <Liquid Crystal Cell>

Any mode of liquid crystal cell can be used in the image display device of the present invention. Preferred modes include a VA mode, OCB mode, IPS mode, and TN mode. In a TN liquid crystal cell, rod liquid crystal molecules are aligned substantially horizontally and are twisted in the range of 60° to 120° during no voltage application. The TN liquid crystal cells are most widely used in color TFT liquid crystal displays, and are described in many publications.

In a VA liquid crystal cell, rod liquid crystal molecules are aligned substantially vertically during no voltage application. The VA liquid crystal cells includes (1) liquid crystal cells of VA mode in a narrow sense in which the rod liquid crystal molecules are aligned substantially vertically during no voltage application and aligned substantially horizontally during voltage application (described in JP-A-2-176625); (2) liquid crystal cells of a multi-domain VA mode (MVA mode) for expanding the viewing angle (SID97, Digest of tech. papers (proceedings) 28 (1997), 845); (3) liquid crystal cells of a mode (n-ASM mode) in which the rod liquid crystal molecules are aligned substantially vertically during no voltage application and are aligned in a form of a twisted multi-domain during voltage application (described in the proceedings of Nippon Ekisho Toronkai (Japanese Liquid Crystal Society)(1998), 58-59); and (4) a liquid crystal cell of SURVIVAL mode (reported at LCD International 98). The VA liquid crystal display device may be driven in any mode of PVA (patterned vertical alignment, photo alignment (optical alignment), and PSA (polymer-sustained alignment). The details of these modes are described in JP-A-2006-215326, and JP-T-2008-538819.

An IPS liquid crystal cell contains rod liquid crystal molecules aligned substantially parallel to the substrate. The liquid crystal molecules respond in plane during application of an electric field parallel to the surface of the substrate. An IPS liquid crystal cell displays black during application of no electric field, and the transmission axes of a pair of upper and lower polarizing plates are orthogonal to each other. Countermeasures for eliminating light leakage in the oblique direction during black display with optically compensatory sheets to expand the viewing angle are disclosed in patent literature such as JP-A Nos. 10-54982, 11-202323, 9-292522, 11-133408, 11-305217, and 10-307291.

### <Polarizing Plate for Stereoscopic Display System>

The stereoscopic display system of the present invention allows the user to recognize a stereoscopic, or especially called 3D image, through the polarizing plate. One embodiment of the polarizing plate relates to polarized glasses. Circular polarized glasses are used in an embodiment where circular polarized images for right and left eyes are formed using a phase difference plate, whereas linear polarized glasses are used in an embodiment where linear polarized images are formed. The glasses are preferably configured so that light of right-eye image output through either one the first and second retardation areas of the optically anisotropic layer is allowed to transmit through the right glass while being stopped by the left glass, and that light of left-eye image output through the other one of the first and second retardation areas is allowed to transmit through the left glass while being stopped by the right glass.

The polarized glasses are configured by a phase difference functional layer and a linear polarizer. Other components having a function equivalent to that of the linear polarizer is also adoptable. Specific configuration of the stereoscopic display system of the present invention, including the polarized glasses, will be explained below. The phase difference plate includes the first retardation area and the second retardation area differing in the polarizing function, respectively provided to form a plurality of first lines and a plurality of second lines alternately arranged over the image display panel (for example, the lines may be horizontal odd-numbered lines and even-numbered lines in a horizontal arrangement, or may be vertical odd-numbered lines and the even-numbered lines in a vertical arrangement). In a configuration making use of circular polarization for display, both of the above-described first retardation area and the second retardation area preferably have a phase difference of λ/4, and more preferably have their slow axes aligned orthogonal to each other.

In the configuration making use of circular polarization, wherein both of the first retardation area and the second retardation area respectively having a phase difference value of λ/4, and being configured to show the right-eye image on the odd-numbered lines of the image display panel, and the retardation area being arranged on the odd-numbered lines and having the slow axis thereof in the 45° direction, it is now preferable to dispose a λ/4 plate for each of the right glass and left glass of the polarized glasses, while adjusting the direction of the slow axis of the right glass of the polarized glasses to approximately 45°, for example. Similarly in this configuration, being configured to show the left-eye image on the even-numbered lines of the image display panel, and the retardation area being arranged on the even-numbered lines and having the slow axis thereof in the 135° direction, it is now preferable to adjust the slow axis of the left glass of the polarized glasses to approximately 135°, for example.

From an additional viewpoint that image light is once output through the patterned retardation film in the form of circular polarized light, and then recovered into the original state of polarization by the polarized glasses, the fixed angle of slow axis of the right glass in the above-described configuration is more preferably adjusted to 45° in the horizontal direction as exactly as possible. On the other hand, it is more preferable that the fixed angle of slow axis of the left glass is closer, as exactly as possible, to 135° (or)-45° in the horizontal direction.

If the image display panel is configured by a liquid crystal display panel, it is generally preferable that the direction of absorption axis of the front polarizing plate of the liquid crystal display panel is aligned in the horizontal direction, and that the absorption axis of the linear polarizer of the polarized glasses is aligned orthogonal to the absorption axis of the front polarizing plate. The absorption axis of the linear polarizer of the polarized glasses is more preferably aligned in the perpendicular direction.

From the viewpoint of conversion efficiency of polarized light, it is preferable that the direction of absorption axis of the front polarizing plate of the liquid crystal display panel is 45° away from each of the slow axes of the retardation areas arranged on the odd-numbered lines and the even-numbered lines of the patterned retardation film.

A preferable arrangement of the polarized glasses, the patterned retardation film and the liquid crystal display device is disclosed, for example, in JP-A-2004-170693.

Examples of the polarized glasses include those described in JP-A-2004-170693, and an accessory of a commercially available 3D monitor ZM-M220W from Zalman Tech. Co. Ltd.

### EXAMPLES

The present invention will further be detailed below, referring to Examples. Note that materials, amount of use, ratio, details of treatment, procedures of treatment and so forth may be modified without departing from the spirit of the present invention. It is, therefore, to be understood that the scope of the present invention is not restrictively interpreted by Examples described below.

### Example A

The first and second films, having optical characteristics listed in Table below were prepared. Various types of the patterned optically anisotropic layers were respectively formed on the first film, while controlling, and then fixing, the state of alignment of a liquid crystal composition, typically making use a patterned photo-alignment film obtained by exposure of light through a mask, a patterned rubbed alignment film obtained by rubbing through a mask, or a patterned alignment film obtained by controlling expression and disappearance of interaction between an additive or the like with the alignment film, to thereby manufacture the FPRs. The liquid crystal composition adopted herein contained a polymerizable rod-like liquid crystal or a polymerizable discotic liquid crystal, optionally added with an additive for controlling alignment, and also with a polymerization initiator for promoting the polymerization. The patterned optically anisotropic layer was a patterned λ/4 layer similar to that illustrated in FIG. 6A, wherein each of the first and second retardation areas showed a phase difference value of λ/4.

On each second film, a hard coating layer and an antireflection film were formed in this order by general procedures, to thereby manufacture the surface film. The back surface of each FPR manufactured in the above (the surface having no patterned optically anisotropic layer formed thereon), and the back surface of the surface film manufactured in the above (the surface having neither the hard coating layer nor the antireflection film formed thereon), were bonded using an optically isotropic pressure sensitive adhesive (SK-2057, from Soken Chemical and Engineering Co. Ltd.).

The optically anisotropic elements, having the configurations listed in Table below, were manufactured.

TABLE 1

| | First film | | Second film | | |
|---|---|---|---|---|---|
| | | Direction | | Direction | |
| | Re | of slow | Re | of slow | Difference |
| | (nm) | axis | (nm) | axis | of Re |
| Example 1 | 5 | 0° | 5 | 90° | 0 |
| Example 2 | 5 | 0° | 10 | 90° | 5 |
| Example 3 | 5 | 0° | 13 | 90° | 8 |
| Example 4 | 5 | 0° | 14 | 90° | 9 |
| Comparative | 5 | 0° | 5 | 0° | 0 |
| Example 1 | | | | | |

Each of the thus-manufactured optically anisotropic elements was laminated on the external of the polarizing film on the viewer's side of a commercially available VA-mode liquid crystal display device.

### (Evaluation of Crosstalk)

In the VA-mode liquid crystal display devices respectively laminated with the optically anisotropic elements, manufactured in Examples 1 to 4 and Comparative Example 1, each optically anisotropic element was disposed so that, as illustrated in FIG. 13, the area of the patterned retardation layer allowing therethrough transmission of the right-eye image (first retardation area) is arranged on the odd-numbered lines (horizontal direction), and so that the area allowing therethrough transmission of the left-eye image (second retardation area) is arranged on the even-numbered lines. On the screen, three display patterns: “display pattern 0” characterized by white display on all lines, “display pattern 1” characterized by black display on the odd-numbered lines and white display on the even-numbered lines, and “display pattern 2” characterized by white display on the odd-numbered lines and black display on the even-numbered lines, were output, and intensity of transmitted light through the left glass and the right glass were measured in the axial direction, in the direction 45° away from the axial direction, and at a polar angle of 5°. The amount of crosstalk at each direction may be determined by an average value of crosstalk (right eye) and crosstalk (left eye) calculated by the equations (1) and (2) below:

crosstalk(right eye)=[(transmitted light through right glass in “display pattern 2”)/(transmitted light through right glass in “display pattern 0”)]×100% Equation (1)

crosstalk(left eye)=[(transmitted light through left glass in “display pattern 1”)/(transmitted light through left glass in “display pattern 0”)]×100% Equation (2)

In Reference Example 1, a display device was manufactured similarly to Example 1, except that glass substrates were used as the first and second films, and was similarly evaluated.

TABLE 2

| | Crosstalk |
|---|---|
| Example 1 | 0 |
| Example 2 | 0.081 |
| Example 3 | 0.208 |
| Example 4 | 0.263 |
| Comparative Example 1 | 0.325 |
| Reference Example 1 | 0.081 |

It is known from Table 2 that the crosstalk may be reduced by orthogonal arrangement of the slow axes of the first film and the second film. In contrast, Comparative Example 1, having the slow axes of the first film and the second film aligned in parallel with each other, was found to show poorer crosstalk as compared with those in Examples. Example 4, having the slow axes of the first film and the second film aligned orthogonal to each other, but with the difference of Re values exceeding 8 nm, was found to show poorer crosstalk as compared with those of other Examples.

### Example B

Next, configurations having a patterned optically anisotropic layer disposed between the third film and the fourth film were evaluated.

The third films listed in Table 3 were respectively prepared, and the patterned optically anisotropic layers were respectively formed on the third films, while controlling, and then fixing, the state of alignment of a liquid crystal composition, typically making use a patterned photo-alignment film obtained by exposure of light through a mask, a patterned rubbed alignment film obtained by rubbing through a mask, or a patterned alignment film obtained by controlling expression and disappearance of interaction between an additive or the like with the alignment film, to thereby manufacture the FPRs. The liquid crystal composition adopted herein contained a polymerizable rod-like liquid crystal or a polymerizable discotic liquid crystal, optionally added with an additive for controlling alignment, and also with a polymerization initiator for promoting the polymerization. The patterned optically anisotropic layer was a patterned λ/4 layer similar to that illustrated in FIG. 6A, wherein each of the first and second retardation areas showed a phase difference value of λ/4.

On the surface of each third film, having no patterned optically anisotropic layer formed thereon, a hard coating layer and an antireflection film were formed in this order by general procedures, to thereby manufacture each surface film having the patterned optically anisotropic layer.

Next, a polarizing plate having a polarizer held between two films was prepared, and then bonded with the patterned optically anisotropic layer having the surface film manufactured in the above, on the surface of the optically anisotropic layer, using an optically isotropic pressure sensitive adhesive (SK-2057, from Soken Chemical and Engineering Co. Ltd.). Of the two films composing the polarizing plate, one film opposed to the surface film having the patterned optically anisotropic layer has characteristics of the fourth film listed in Table 3.

TABLE 3

| | Third film | | Fourth film | | |
|---|---|---|---|---|---|
| | | Direction | | Direction | |
| | Re | of slow | Re | of slow | Difference |
| | (nm) | axis | (nm) | axis | of Re |
| Example 5 | 5 | 90° | 5 | 0° | 0 |
| Comparative | 5 | 0° | 5 | 0° | 0 |
| Example 2 | | | | | |

A commercially available VA-mode liquid crystal display device was prepared, the polarizing film on the viewer's side was removed, and thereon the bonded product of the polarizing plate and the surface film having the patterned optically anisotropic layer, manufactured in the above, was bonded using a pressure sensitive adhesive (SK-2057, from Soken Chemical and Engineering Co. Ltd.).

The thus-manufactured VA-mode liquid crystal display devices, laminated with the optically anisotropic elements of Example 5 and Comparative Example 2, were allowed to stand under a dry condition at 25° C. with a humidity of 10% for 48 hours, and the crosstalk was evaluated. Results are shown Table 4.

TABLE 4

| | Crosstalk |
|---|---|
| Example 5 | 0.244 |
| Comparative | 0.325 |
| Example 2 | |

It is known from Table 4 that the crosstalk may be reduced by orthogonal arrangement of the slow axes of the third film and the fourth film. In contrast, Comparative Example 2, having the slow axes of the third film and the fourth film aligned in parallel with each other, was found to show poorer crosstalk as compared with that in Example 5.

The present disclosure relates to the subject matter contained in Japanese Patent Application No. 108585/2011 filed on May 13, 2011 and Japanese Patent Application No. 093183/2012 filed on Apr. 16, 2012, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optically anisotropic element having a patterned optically anisotropic layer which contains a first retardation area and a second retardation area differing from each other in at least either the direction of in-plane slow axes or the in-plane retardation; and
wherein the first and second retardation area are alternately arranged in plane,
the patterned optically anisotropic layer is disposed on a surface of a laminate having a first film and a second film; and
an in-plane slow axis of the first and an in-plane slow axis of the second film are orthogonal to each other.

2. The optically anisotropic element according to claim 1, wherein difference between values of the in-plane retardation Re(550) at 550 nm of the first film and the second film is 8 nm or smaller.

3. The optically anisotropic element according to claim 1, wherein each of the values of in-plane retardation Re(550) at 550 nm of the first film and the second film is 20 nm or smaller.

4. The optically anisotropic element according to claim 1, wherein either one of the first film and the second film has the slow axis aligned in parallel with the MD direction, and the other has the slow axis aligned in parallel with the TD direction.

5. The optically anisotropic element according to claim 1, having no other layer between the first film and the second film, or having only an optically isotropic layer between the first film and the second film.

6. The optically anisotropic element according to claim 1, further comprising a surface layer composed of a cured film, disposed on the surface of the laminate opposite to the surface thereof having the patterned optically anisotropic layer disposed thereon.

7. An optically anisotropic element comprising a third film, a patterned optically anisotropic layer, and a fourth film laminated in this order,
wherein the patterned optically anisotropic layer contains a first retardation area and a second retardation area differing from each other in at least either the direction of in-plane slow axes or the in-plane retardation, and the first and second retardation area are alternately arranged in plane,
the third and fourth films have their in-plane slow axes in parallel with, or normal to the direction of molecular alignment, and,
the in-plane slow axes are aligned orthogonal to each other.

8. The optically anisotropic element according to claim 7, wherein difference between values of the in-plane retardation Re(550) at 550 nm of the third film and the fourth film is 8 nm or smaller.

9. The optically anisotropic element according to claim 7, wherein each of the values of in-plane retardation Re(550) at 550 nm of the third film and the fourth film is 20 nm or smaller.

10. The optically anisotropic element according to claim 7, further comprising a surface layer composed of a cured film, disposed on the surface of the third film opposite to the surface thereof having the patterned optically anisotropic layer disposed thereon.

11. A polarizing plate comprising a polarizing film, and an optically anisotropic element described in claim 1.

12. The polarizing plate according to claim 11, wherein the optically anisotropic element is the optically anisotropic element described in claim 1, the patterned optically anisotropic layer being bonded to the polarizing film.

13. The polarizing plate according to claim 11, wherein the optically anisotropic element is the optically anisotropic element described in claim 7, the fourth film being bonded to the polarizing film.

14. A stereoscopic display device comprising at least:
a display panel driven based on image signals: and
the optically anisotropic element described in claim 1, disposed on the viewer's side of the display panel.

15. The stereoscopic display device according to claim 14, wherein the display panel has a liquid crystal cell.

16. A stereoscopic display system comprising at least the stereoscopic display device described in claim 14, and a polarizing plate disposed on the viewer's side of the stereoscopic display device, configured to allow recognition of stereoscopic through the polarizing plate.

17. A polarizing plate comprising a polarizing film, and an optically anisotropic element described in claim 7.

18. A stereoscopic display device comprising at least:
a display panel driven based on image signals: and
the optically anisotropic element described in claim 7, disposed on the viewer's side of the display panel.

19. The stereoscopic display device according to claim 18, wherein the display panel has a liquid crystal cell.

20. A stereoscopic display system comprising at least the stereoscopic display device described in claim 18, and a polarizing plate disposed on the viewer's side of the stereoscopic display device, configured to allow recognition of stereoscopic through the polarizing plate.
